(19) United States
(12) Patent Application Publication
(10) Pub. No.: US 2026/0133763 A1
(43) Pub. Date: May 14, 2026

(54) ELECTRONIC DEVICE PERFORMING CALCULATION USING ARTIFICIAL INTELLIGENCE MODEL, AND METHOD FOR OPERATING ELECTRONIC DEVICE

(71) Applicant: SAMSUNG ELECTRONICS CO., LTD., Suwon-si, Gyeonggi-do (KR)

(72) Inventors: Hyunbin PARK, Suwon-si, Gyeonggi-do (KR); Junhyuk LEE, Suwon-si, Gyeonggi-do (KR); Boyeon NA, Suwon-si, Gyeonggi-do (KR)

(21) Appl. No.: 19/437,480

(22) Filed: Dec. 31, 2025

Related U.S. Application Data
(63) Continuation of application No. PCT/KR2024/009364, filed on Jul. 3, 2024.

(30) Foreign Application Priority Data
Jul. 3, 2023 (KR) 10-2023-0085821
Aug. 9, 2023 (KR) 10-2023-0104046

(51) Int. Cl. G06F 7/544; G06F 5/01; G06F 7/50; G06F 7/523; G06F 7/535

(52) U.S. Cl. CPC G06F 7/5443; G06F 5/01; G06F 7/50; G06F 7/523; G06F 7/535

(57) ABSTRACT

An electronic device for performing a multiply and accumulate (MAC) operation includes at least one MAC unit, a memory, at least one 8b×8b operator, at least one 8b×4b operator, at least one 4b×4b operator, a bit shifter, an adder, at least one accumulator, and a processor. The processor receives first bit string data and second bit string data which include 12 bits, divides the first bit string data into 4 bits and 8 bits, divides the second bit string data into 4 bits and 8 bits, outputs two 8-bit results corresponding to activation 8-bit, weight 8-bit (A8W8) by using the bit shifter and a first accumulator on the basis of determining to output an A8W8 result, and outputs one 12-bit result corresponding to activation 12-bit, weight 12-bit (A12W12) on the basis of determining to output an A12W12 result.

### CROSS-REFERENCE TO RELATED APPLICATIONS

This application is a continuation application under, 35 U.S.C. § 111(a), of International Application No. PCT/KR 2024/009364 designating the United States, filed on Jul. 3, 2024, in the Korean Intellectual Property Receiving Office and claiming priority to Korean Patent Application No. 10-2023-0085821, filed on Jul. 3, 2023 in the Korean Intellectual Property Office and Korean Patent Application No. 10-2023-0104046, filed on Aug. 9, 2023 in the Korean Intellectual Property Office, the disclosures of which are incorporated by reference herein in their entireties.

### BACKGROUND

### Technical Field

Various embodiments of the present disclosure relate to an electronic device performing calculation using an artificial intelligence model, and a method for operating an electronic device.

### Description of Related Art

An artificial neural network (ANN) refers to a computational architecture that models a biological brain. Based on an artificial neural network, deep learning, machine learning, or the like may be implemented. As an example of an artificial neural network, a deep neural network or deep learning may have a multi-layer structure that includes a plurality of layers.

In technology fields that analyze vision and speech, an artificial intelligence model (AI model) is being utilized diversely. To operate an AI model effectively in a mobile terminal, research and development for hardware technology related to an artificial intelligence model is actively being conducted.

In addition, a data processing system may include at least one processor known generally as a central processing unit (CPU). Such a data processing system may also include at least one other processor used for specialized processing of various types, for example a neural processing unit (NPU).

### SUMMARY

An electronic device that performs a multiply and accumulate (MAC) operation includes at least one MAC unit, a memory, at least one 8b×8b operator, at least one 8b×4b operator, at least one 4b×4b operator, a bit shifter, an adder, at least one accumulator, and a processor. The processor executes instructions that control the electronic device to receive first bit string data and second bit string data composed of 12 bits, divide first bit string data into 4 bits and 8 bits, divide the second bit string data into 4 bits and 8 bits, output two 8-bit results corresponding to activation 8-bit, weight 8-bit (A8W8) by using the bit shifter and a first accumulator based on being determined to output a result of A8W8, and output one 12-bit result corresponding to activation 12-bit, weight 12-bit (A12W12) based on being determined to output a result of A12W12.

In an embodiment, an electronic device includes an operation circuit, a memory, and a processor. The operation circuit includes a plurality of multiplexers, a bit shifter, an adder, and a storage space including an accumulator. The processor controls the electronic device to select a first path capable of outputting a result of activation 8-bit, weight 8-bit (A8W8), or selects a second path capable of outputting a result of activation 12-bit, weight 12-bit (A12W12), within the operation circuit.

A method of operating an electronic device performing a calculation by using an artificial intelligence model includes receiving first bit string data and second bit string data composed of 12 bits, dividing the first bit string data into four bits and eight bits, dividing the second bit string data into four bits and eight bits, outputting two 8-bit results corresponding to activation 8-bit, weight 8-bit (A8W8) by using a bit shifter and a first accumulator based on being determined to output a result of A8W8, and an operation of outputting one 12-bit result corresponding to activation 12-bit, weight 12-bit (A12W12) based on being determined to output a result of A12W12.

An electronic device performing an operation by using an artificial intelligence model may perform an operation by dividing 12-bit data into 4 bits and 8 bits by using one MAC and may selectively output a result corresponding to A8W8 and A12W12.

An electronic device performing an operation by using an artificial intelligence model may process 8-bit data and may also process 12-bit data according to a user's selection.

An electronic device performing an operation by using an artificial intelligence model may perform an operation efficiently without wasted bits on a computer system operated in 32 bits or 64 bits while processing 12-bit data.

### BRIEF DESCRIPTION OF DRAWINGS

FIG. 1 is a block diagram of an electronic device in a network environment according to various embodiments.

FIG. 2 illustrates a configuration of an electronic device according to an embodiment in a block diagram.

FIG. 3A illustrates a structure of a multiply and accumulate (MAC) unit performing multiplication and result accumulation according to various embodiments.

FIG. 3B illustrates a multiplication method between 4-bit data according to various embodiments.

FIG. 4A illustrates a process of dividing 12-bit data into four sections according to various embodiments.

FIG. 4B illustrates a process of obtaining an A8W8 result through multiplication and sum operations of data divided into four sections according to various embodiments.

FIG. 4C illustrates a process of obtaining an A12W12 result through multiplication and sum operations of data divided into four sections according to various embodiments.

FIG. 5A illustrates a process of obtaining an A8W8 result through multiplication and sum operations by using a MAC unit according to various embodiments.

FIG. 5B illustrates a first embodiment in which, when multiple MAC units shown in FIG. 5A are present, input values are shared among the multiple MAC units.

FIG. 6A illustrates a process of obtaining an A12W12 result through multiplication and sum operations by using a MAC unit according to various embodiments.

FIG. 6B illustrates a second embodiment in which input values are shared among multiple MAC units according to various embodiments.

FIG. 7A and FIG. 7B illustrate a process of obtaining A8W8 and A12W12 results by packing data in units of 8 bits and 4 bits according to various embodiments.

FIG. 7C illustrates a process of performing a 3×3 convolution operation according to an embodiment.

FIG. 8 illustrates an operation method of an electronic device performing an operation by using an artificial intelligence model according to an embodiment, in a flowchart.

### DETAILED DESCRIPTION

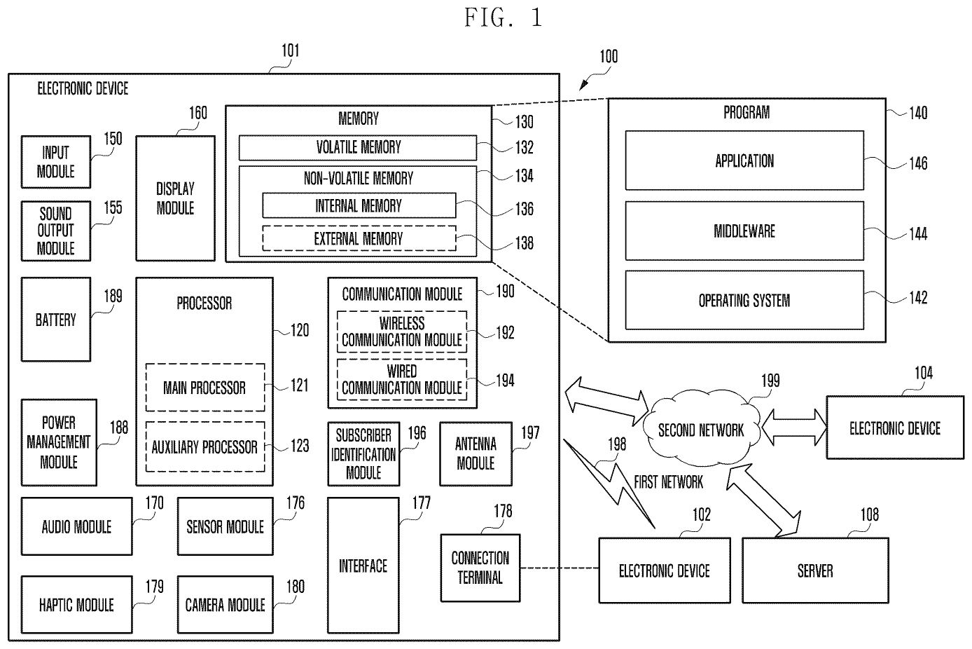

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

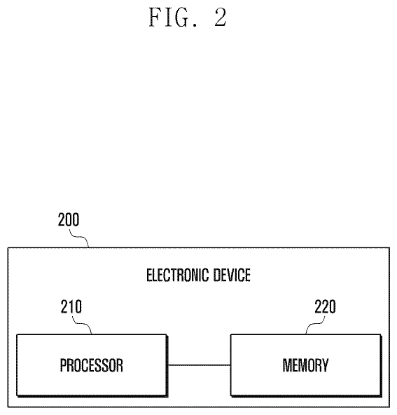

FIG. 2 illustrates a configuration of an electronic device according to an embodiment in a block diagram.

According to FIG. 2, an electronic device 200 may include a processor 210 and a memory 220, and some of illustrated configurations may be omitted or substituted. The electronic device 200 may further include at least a part of a configuration and/or a function of the electronic device 101 of FIG. 1. At least a part of each configuration of illustrated (or non-illustrated) electronic device 200 may be connected operatively, functionally, and/or electrically.

According to an embodiment, the processor 210 may be configured to perform an operation or data processing related to control and/or communication of respective constituent elements of the electronic device 200 and may be composed of one or more processors. The processor 210 may include at least a part of a configuration and/or a function of the processor 120 of FIG. 1.

According to an embodiment, there is no limitation on an operation and data processing function that the processor 210 may implement on the electronic device 200, but hereinafter, a feature of dividing 12-bit data into 8 bits and 4 bits for deep learning operation and controlling the same will be described in detail. Operations of the processor 210 may be performed by loading instructions stored in the memory 220.

According to an embodiment, the electronic device 200 may include one or more memories 220, and the memory 220 may include main memory and storage. The main memory may be composed of volatile memory such as, for example, dynamic random access memory (DRAM), static RAM (SRAM), or synchronous dynamic RAM (SDRAM). Alternatively, the memory 220 may include a large-capacity storage device as non-volatile memory. The storage may include at least of among one time programmable ROM (OTPROM), PROM, EPROM, EEPROM, mask ROM, flash ROM, flash memory, a hard drive, or a solid state drive (SSD). The memory 220 may store various file data, and stored file data may be updated according to operations of the processor 210.

Deep learning may be performed through a sum of multiplications of weight and input. By applying an activation function to a calculation result obtained through a sum of multiplications of weight and input, a final result value (activation) may be obtained. Data corresponding to A8W8 may have a size of 8 bits. A8W8 may mean activation 8bit and weight 8bit. Activation may mean a size of input data. Weight may mean a variable for adjusting an influence that input data exerts on a result. Data corresponding to A12W12 may have a size of 12 bits. Because a general computer system uses 32 bits or 64 bits, when receiving 12-bit data, both 32 bits and 64 bits may have remaining bits. For example, when a computer system receives 12-bit data into 32 bits, 8 bits may remain. Also, when a computer system receives 12-bit data into 64 bits, 4 bits may remain. According to one example, when learning data in an A12W12 form, A12W12 may have good efficiency compared to another system (e.g., A8W8), but wasted bits may occur.

A camera image sensor may perform noise removal and distortion correction by using an image signal processor (ISP) for data before processing (raw data) of a 12-bit data format. The image signal processor (ISP) may receive 12-bit data from a camera image sensor and may increase a quality of an image through deep learning pixel processing. When the processor (e.g., NPU) 210 performs Neural ISP processing (deep learning pixel processing) with A8W8 precision, loss may occur in 12-bit Bayer data. When an NPU processes 12-bit Bayer data with A16W8 precision, there may be no loss of data, but because 8 bits are used for weight, bit width may be insufficient, causing deterioration of image quality. If an NPU supports A12W12, 12-bit weight may be utilized without loss of Bayer data, so compatibility may be good. Therefore, an NPU capable of processing A12W12 data may be used. According to an embodiment, the processor 210 may include a neural processing unit (NPU) or may be implemented as an NPU.

According to an embodiment, the processor 210 may divide the first bit string data into four bits and eight bits, divide the second bit string data into four bits and eight bits, output two 8-bit results corresponding to activation 8-bit, weight 8-bit (A8W8) by using a bit shifter and a first accumulator based on being determined to output a result of A8W8, and output one 12-bit result corresponding to activation 12-bit, weight 12-bit (A12W12) based on being determined to output a result of A12W12.

According to an embodiment, the processor 210 may receive first bit string data and second bit string data composed of 12 bits, divide upper four bits of the first bit string data into a first section, divide lower eight bits of the first bit string data into a second section, divide upper four bits of the second bit string data into a third section, divide lower eight bits of the second bit string data into a fourth section, perform multiplication of data of the first section through the fourth section based on an input signal, adds multiplication results, output a result of activation 8-bit, weight 8-bit (A8W8) or output a result of activation 12-bit, weight 12-bit (A12W12).

According to an embodiment, the processor 210 may output a result of activation 8-bit, weight 8-bit (A8W8) or may output a result of activation 12-bit, weight 12-bit (A12W12) by using a multiplexer and a bit shifter.

According to an embodiment, the processor 210 may perform multiplication for the second section and the fourth section to determine a first result value, calculate (or compute) multiplication for the fourth section and the third section, determine a second result value by shifting upward by four bits by using the bit shifter, calculate multiplication for the fourth section and the first section and determines a third result value, output the first result value, and output a result by performing a sum operation on the second result value and the third result value.

According to an embodiment, the processor 210 may perform multiplication for bits corresponding to the second section and bits corresponding to the fourth section to determine a first result value, perform multiplication for bits corresponding to the second section and bits corresponding to the third section, determine a second result value by shifting upward by eight bits by using the bit shifter for a result value obtained by multiplication, perform multiplication for bits corresponding to the first section and bits corresponding to the third section, determine a third result value by shifting upward by eight bits by using the bit shifter for a result value obtained by multiplication, perform multiplication for bits corresponding to the first section and bits corresponding to the fourth section, determine a fourth result value by shifting upward by eight bits by using the bit shifter for a result value obtained by multiplication, and output a result by performing a sum operation on the first result value to the fourth result value.

According to an embodiment, the processor 210 may include a neural processing unit (NPU) or may be implemented as an NPU.

According to an embodiment, the processor 210 may perform a multiplication operation for bits corresponding to the second section and bits corresponding to the fourth section and may accumulate a result obtained by multiplication.

According to an embodiment, the processor 210 may perform a sum operation on a result value obtained by performing a multiplication operation between one of bits corresponding to the second section or bits corresponding to the fourth section and bits corresponding to the third section, and a result value obtained by performing a multiplication operation between bits corresponding to the fourth section and bits corresponding to the first section, and perform a multiplication operation for bits corresponding to the third section and bits corresponding to the first section and may accumulate a result.

According to an embodiment, the processor 210 may perform multiplication operations for sections divided into eight bits for first bit string data and second bit string data composed of 12 bits and determine a first value, perform multiplication operations for eight-bit sections and four-bit sections and determines a second value, perform multiplication operations for sections divided into four bits and determine a third value, and may accumulate and store a result by summing the first value, the second value, and the third value.

According to an embodiment, the processor 210 may perform multiplication of data of the first section through the fourth section by using a multiply and accumulate (MAC) unit and may add multiplication results. The processor 210 may determine whether to output a result of activation 8-bit, weight 8-bit (A8W8) or to output a result of activation 12-bit, weight 12-bit (A12W12) based on an external input.

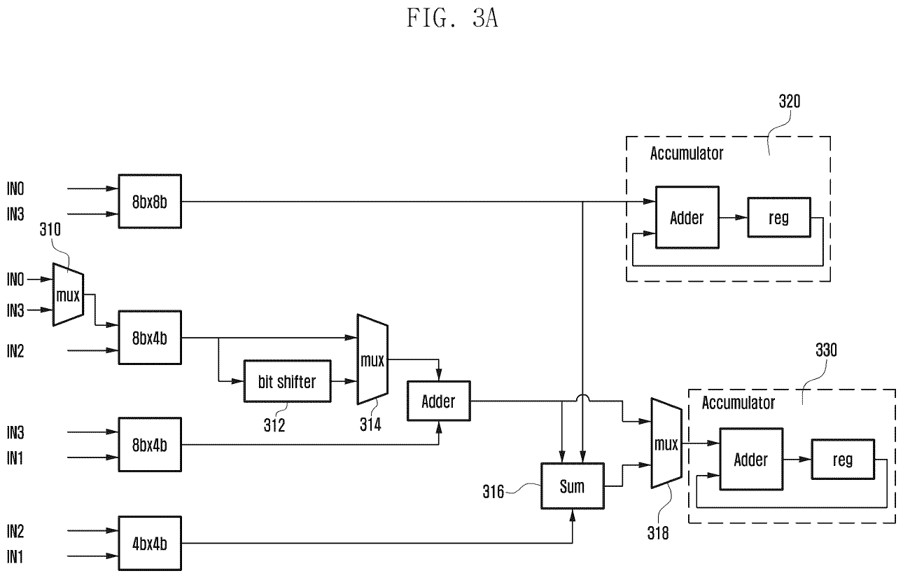

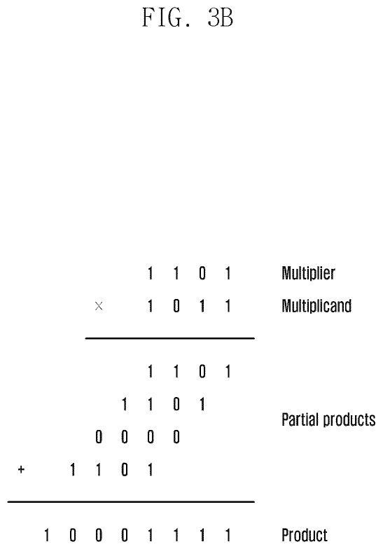

FIG. 3A illustrates a structure of a MAC unit performing multiplication and result accumulation.

According to FIG. 3A, a MAC unit performs a multiplication operation of input data and may perform a sum operation. The MAC unit may include three multiplexers (mux) 310 and one bit shifter 312. A multiplexer (mux) 310 may be used to select any one among a plurality of inputs. The bit shifter 312 may be used to shift (or change) a bit position of at least one bit during a bit-wise operation process. For example, first bit string data composed of four bits positioned at 0 to 3 in bit string data composed of 12 bits may be changed to be positioned at 4 to 7 by a four-bit shift. A bit-wise operation process will be described in detail in FIG. 3B.

The MAC unit may store a result value obtained by performing a multiplication operation between eight bits on a first accumulator 320.

The MAC unit may perform a multiplication operation between 8 bits and 4 bits by using two multiplexers (mux) 310 and 314 and a bit shifter 312. The MAC unit may perform a multiplication operation between 4 bits and 4 bits. The MAC unit may perform a sum operation on a result value of a multiplication operation between 8 bits and 8 bits, a result value of a multiplication operation between 8 bits and 4 bits, and a result value of a multiplication operation between 4 bits and 4 bits by using an adder 316. The MAC unit may store a result value obtained by performing a sum operation and a result value obtained by performing a multiplication operation between 8 bits and 4 bits in a second accumulator 330 through a third multiplexer 318.

FIG. 3b illustrates a multiplication method between 4-bit data.

The MAC unit may perform a multiplication operation between 4 bits. FIG. 3B is merely one example, and the MAC unit may perform a multiplication operation between data having other bits.

For example, the MAC unit may perform a multiplication operation between 4-bit data having ‘1101’ and 4-bit data having ‘1011’. The MAC unit may perform a multiplication operation one bit-position at a time for data having ‘1011’ on 4-bit data having ‘1101’. The MAC unit may multiply a bit 1 corresponding to a first bit position from the right of 1101 and 1011. The MAC unit may multiply a bit 1 corresponding to a second bit position from the right of 1101 and 1011 and may shift upward by one bit for a result of the multiplication. The MAC unit may multiply a bit 0 at a third bit position from the right of 1101 and 1011 and may shift upward by two bits for a result of the multiplication. The MAC unit may multiply a bit 1 positioned at a fourth bit position from the right of 1101 and 1011 and may shift upward by three bits for a result of the multiplication. The MAC unit may determine a final value by summing all result values of multiplication operations for each bit position. In FIG. 3B, a result of a multiplication operation between 4-bit data having ‘1101’ and 4-bit data having ‘1011’ may be represented as ‘10001111’.

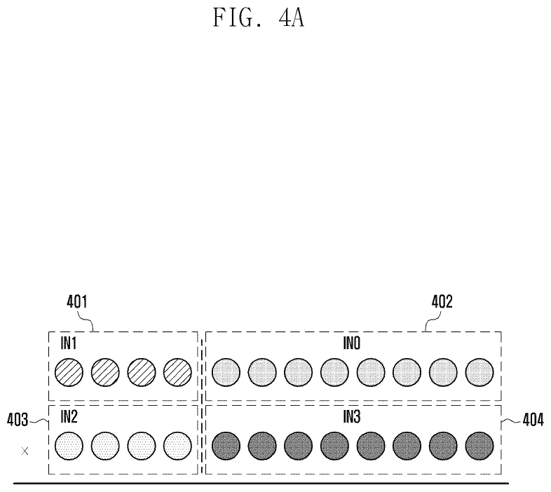

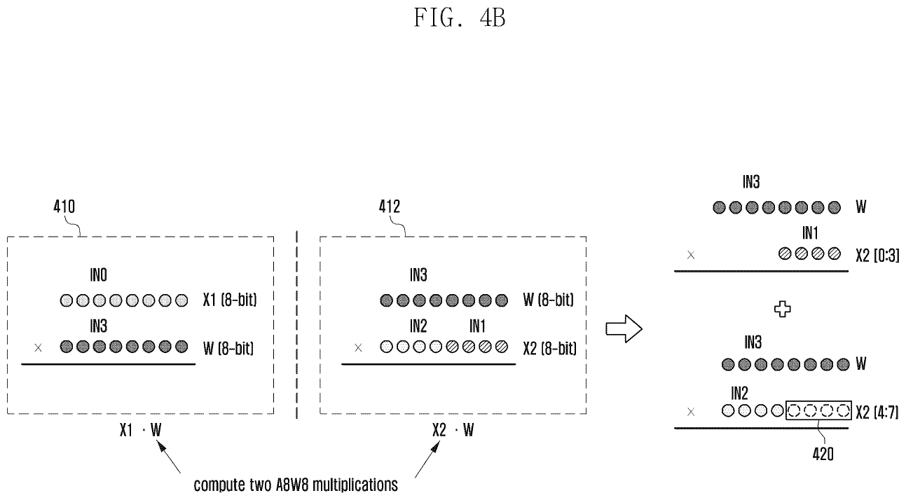

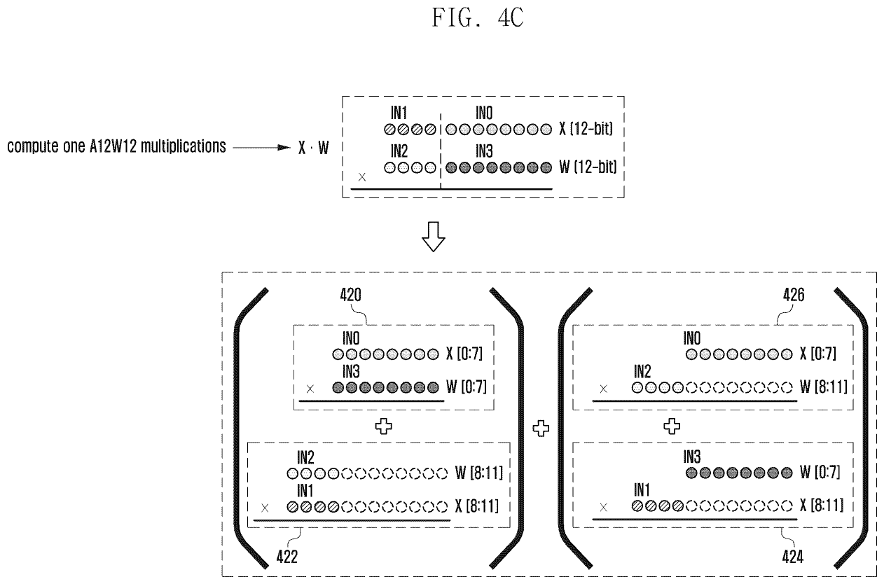

FIG. 4a illustrates a process of dividing 12-bit data into four sections.

According to FIG. 4A, the processor (e.g., the processor 210 of FIG. 2) may divide upper four bits of first bit string data into a first section 401 (IN1) and may divide lower eight bits of the first bit string data into a second section 402 (IN0). The processor 210 may divide upper four bits of second bit string data into a third section 403 (IN2) and may divide lower eight bits of the second bit string data into a fourth section 404 (IN3). Alternatively, the processor 210 may divide upper eight bits of first bit string data into the first section 401 (IN1) and may divide lower four bits of the first bit string data into the second section 402 (IN0). The processor 210 may also divide upper eight bits of second bit string data into the third section 403 (IN2) and may divide lower four bits of the second bit string data into the fourth section 404 (IN3). That is, the first bit string data and the second bit string data may be divided into eight bits and four bits, but eight bits may be arranged at upper positions and four bits may be arranged at lower positions, or conversely, eight bits may be arranged at lower positions and four bits may be arranged at upper positions. At least one of the first bit string data or the second bit string data may include data having 12 bits (e.g., image data).

The processor 210 performs multiplication of data of the first section 401, the second section 402, the third section 403, and the fourth section 404 and may output a final result by adding multiplication results together. The processor 210 may output a result of activation 8-bit, weight 8-bit (A8W8) or may output a result of activation 12-bit, weight 12-bit (A12W12) based on an external input (e.g., user input). The processor 210 may perform multiplication of data and may determine in advance, based on an external input, whether to output A8W8 or A12W12 before adding multiplication results.

A process of outputting at least one of A8W8 or A12W12 will be described in FIG. 4B and FIG. 4C. In FIG. 4A, one bit string data composed of 12 bits is described as being divided into upper four bits and lower eight bits, but this is for convenience of explanation and a dividing method of data is not limited thereto. Bit string data may be divided, for example, into upper eight bits and lower four bits, and such a dividing method may vary depending on settings.

FIG. 4B illustrates a process of obtaining an A8W8 result through multiplication and sum operations of data divided into four sections. The processor 210 may perform a calculation to obtain two A8W8 results in one cycle by combining IN0, IN1, IN2, and IN3. X1 and X2 may mean 8-bit input values. IN may mean a name of an input of the MAC unit. One MAC unit may execute X1*W and X2*W within one cycle. W may mean an 8-bit weight. The processor 210 may assign a first input X1 to a section divided into eight bits and may assign a weight W to another section divided into eight bits. The processor 210 may assign lower four bits of a second input X2 to a section divided into four bits (e.g., IN1) and may assign upper four bits of X2 to another section divided into four bits (e.g., IN2). The processor 210 may assign the first input X1 to IN0 and may assign the weight W to IN3. Or conversely, the processor 210 may assign the first input X1 to IN3 and may assign the weight W to IN0. Whether X1 and W are assigned may vary depending on settings.

The processor 210 may assign lower four bits of the second input X2 to IN1 and may assign upper four bits of X2 to IN2. Or conversely, the processor may assign lower four bits of the second input X2 to IN2 and may assign upper four bits of X2 to IN1.

A method of assigning X1, X2, and W to IN0, IN1, IN2, and IN3 may vary depending on settings and is not limited to what is illustrated in FIG. 4B. FIG. 4B illustrates an example in which the first input X1 is assigned to IN0, the weight W is assigned to IN3, lower four bits of the second input X2 are assigned to IN2, and upper four bits of X2 are assigned to IN1 according to an embodiment.

According to FIG. 4B, the processor 210 may perform a multiplication operation of the second section 402 and the fourth section 404 having a size of eight bits. The processor 210 may perform a multiplication operation of the second section 402 and the fourth section 404 having a size of eight bits and may obtain a first 8-bit result value corresponding to A8W8. Multiplication between 8 bits may be performed as described in FIG. 3B. FIG. 3B illustrates a process of obtaining eight bits by performing multiplication between 4 bits. Likewise, when multiplication between 8 bits is performed, a result of 16 bits may be obtained. The processor 210 may convert (quantize) a 16-bit value obtained as a result of multiplication between 8 bits into eight bits. The processor 210 may perform conversion from INT16 to INT8 by multiplying a scaling factor (a constant value) and adding a bias. The processor 210 may provide a value converted into eight bits as an input of a next layer.

In diagram 410, the processor 210 may obtain a first A8W8 result value by performing a multiplication operation of X1 (8 bits) and W (8 bits). This may be performed similarly to a process in which multiplication of a 4-bit operation is performed in FIG. 3B.

Additionally, the processor 210 may perform a multiplication operation of eight-bit data obtained by combining the first section 401 and the third section 403 with respect to the fourth section 404. The processor 210 may determine a first result value by performing a multiplication operation of the fourth section 404 and the first section 401. The processor 210 may perform a multiplication operation of the fourth section 404 and the third section 403 and may determine a second result value by shifting upward by four bits by using a bit shifter for a result of the multiplication operation. The processor 210 may obtain a second 8-bit result value corresponding to A8W8 by summing the first result value and the second result value.

In diagram 412, the processor 210 may perform a multiplication operation of X2 (8 bits) and W (8 bits). X2 may be composed of IN1 including first to fourth bits from the right and IN2 including fifth to eighth bits from the right. The processor 210 may perform a multiplication operation of W (8 bits) and IN1. Additionally, the processor 210 may perform a multiplication operation of W (8 bits) and IN2. However, because IN2 includes fifth to eighth bits, first to fourth bits from the right may be omitted.

Diagram 420 illustrates a process of adding bit positions to IN2 in which first to fourth bits from the right are omitted and performing a multiplication operation with W (8 bits). The processor 210 may perform a multiplication operation of IN3 and IN1 and may perform a multiplication operation of IN3 and IN2. Subsequently, the processor 210 may add a multiplication operation value of IN3*IN2 to a multiplication operation value of IN3 and IN1 to be offset by four bits in an upper-bit direction. The processor 210 may determine a result value of a multiplication operation of X2 and W by adding a multiplication operation value of IN3*IN2 to a multiplication operation value of IN3 and IN1 to be offset by four bits in an upper-bit direction. The processor 210 may obtain a second A8W8 result value by respectively multiplying four-bit values to an eight-bit value and then adding to offset by four bits in an upper-bit direction. That is, in FIG. 4B, the processor 210 may output two 8-bit result values.

FIG. 4C illustrates a process of obtaining an A12W12 result through multiplication and sum operations of data divided into four sections.

According to FIG. 4C, the processor 210 may perform a multiplication operation by dividing two bit string data having a size of 12 bits into a first section 401 to a fourth section 404. X may mean a 12-bit input. W may mean an 12-bit weight. One MAC unit may perform a multiplication operation between X and W within one cycle. The processor 210, when assigning X to IN0 and IN1, may assign W to IN2 and IN3. Conversely, when W is assigned to IN0 and IN1, the processor 210 may assign X to IN2 and IN3. In the following description and drawings, an embodiment in which X is assigned to IN0 and IN1 and W is assigned to IN2 and IN3 is illustrated for convenience of explanation, but this is merely an embodiment and positions to which X and W are assigned may vary depending on settings. The processor 210 may assign upper four bits of the input X to IN1. In addition, the processor 210 may assign lower eight bits of the input X to IN0. The processor 210 may assign upper four bits of W to IN2. The processor 210 may assign lower eight bits of W to IN3. The processor 210 may perform a multiplication operation of IN0 and IN3 and may obtain a result value of a multiplication operation of X and W by adding, to the result value (of the multiplication operation of IN0 and IN3), IN2*IN1 to be offset by sixteen bits in an upper-bit direction and by adding, to the result value, IN0*IN2 and IN3*IN1 to be offset by eight bits in an upper-bit direction. The processor 210 may obtain a result value of a multiplication operation of X and W even without using a bit shifter.

In diagram 420, the processor 210 may perform a multiplication operation of IN0 and IN3 having a size of eight bits. A multiplication operation of IN0 and IN3 may be performed as multiplication between eight bits similarly to a method described in FIG. 3B.

In diagram 422, the processor 210 may perform a multiplication operation of IN2 and IN1 having a size of four bits. IN2 may include upper four bits of W, and IN1 may include upper four bits of the input X. An electronic device according to this document (e.g., the electronic device 200 of FIG. 2) may perform a multiplication operation of IN0 and IN3 and may obtain a result value of a multiplication operation of X and W by adding, to the result value (of the multiplication operation of IN0 and IN3), IN0*IN2 and IN3*IN1 to be offset by eight bits in an upper-bit direction and by adding, to the result value, IN2*IN1 to be offset by sixteen bits in an upper-bit direction. The electronic device 200 may obtain a result value of a multiplication operation of X and W even without using a bit shifter.

In diagram 424, the processor 210 may perform a multiplication operation of IN3 having a size of eight bits and IN1 having a size of four bits. The processor 210 may shift IN1 by eight bits in an upper-bit direction and perform a multiplication operation with IN3.

In diagram 426, the processor 210 may perform a multiplication operation of IN0 having a size of eight bits and IN2 having a size of four bits. The processor 210 may shift IN2 by eight bits in an upper-bit direction and may perform a multiplication operation with IN0.

The processor 210 may perform a sum operation of diagram 420 and diagram 422 and may perform a sum operation of diagram 424 and diagram 426. The processor 210 may determine a 12-bit output value corresponding to A12W12 by summing a result value of the sum operation of diagram 420 and diagram 422 and a result value of the sum operation of diagram 424 and diagram 426.

That is, in FIG. 4C, the processor 210 may output one 12-bit result value in one cycle.

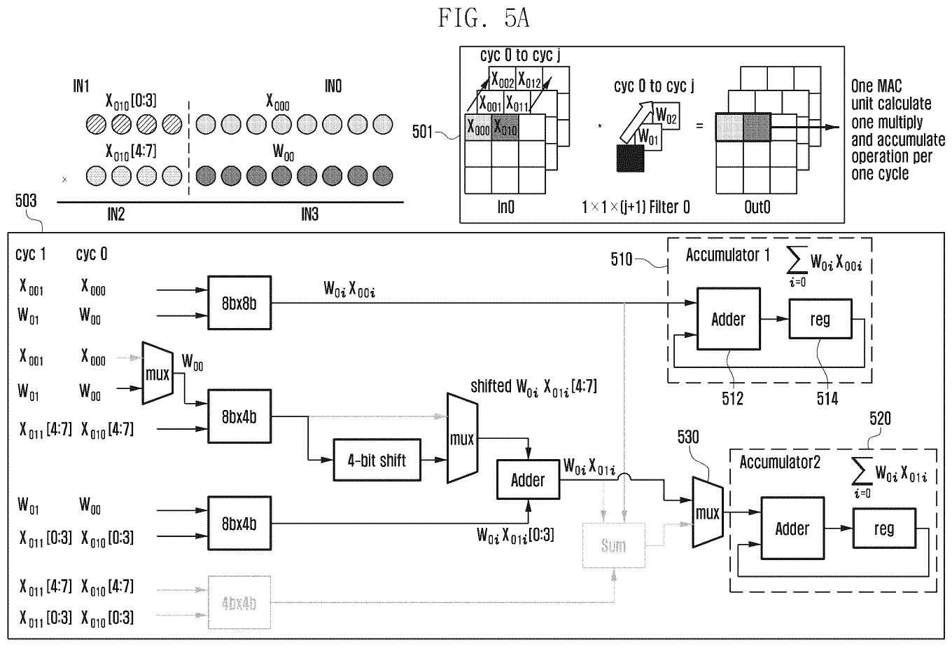

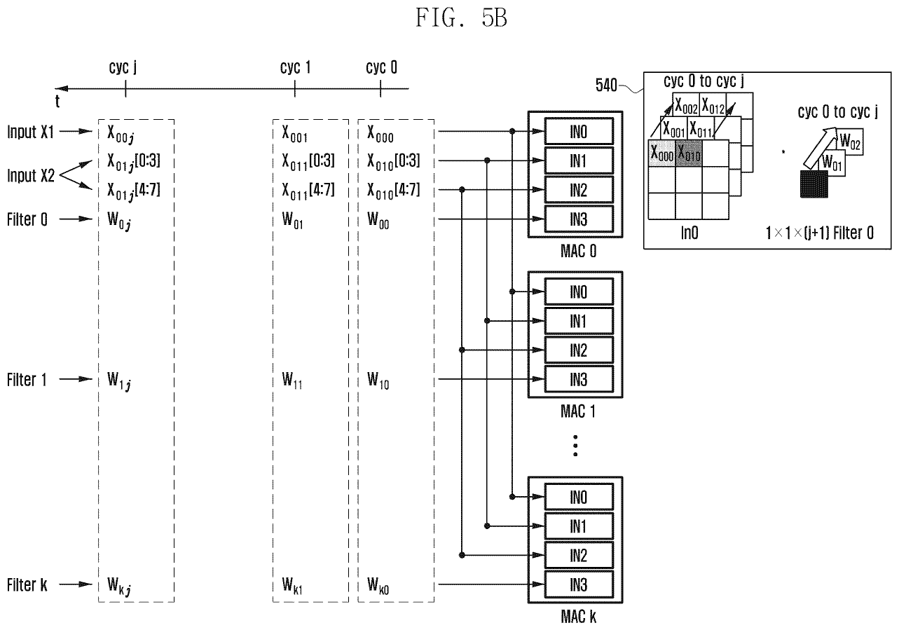

FIG. 5A illustrates a process of obtaining an A8W8 result through multiplication and sum operations by using a MAC unit.

A process of obtaining an 8-bit result corresponding to A8W8 is described in FIG. 4B above. A structure and operation of a MAC unit are described in FIG. 3A.

In FIG. 5A, one bit string data composed of 12 bits is described as being divided into upper four bits and lower eight bits, but this is for convenience of explanation and a dividing method of data is not limited thereto. Bit string data may be divided, for example, into upper eight bits and lower four bits, and such a dividing method may vary depending on settings. A process of determining input values of IN0 (eight bits) and IN1 (four bits) is described in FIG. 4B, and FIG. 5A and FIG. 5B are merely one among various embodiments and are not limited thereto.

Diagram 501 illustrates a process in which the electronic device (e.g., the electronic device 200 of FIG. 2) performs convolution under control of the processor (e.g., the processor 210 of FIG. 2). In cycle 0, X1 may be assigned to Xooo, X2 may be assigned to Xo1o, and W may be assigned to Woo. One MAC unit may perform a multiplication operation of Xooo and Woo and may perform a multiplication operation of Xo1o and Woo in one cycle (e.g., cycle 0). The electronic device 200 may obtain two A8W8 result values in one cycle by using result values of two multiplication operations.

The electronic device 200 may perform a MAC operation with Xoo1, Xo11, and Wo1 in cycle 1. The electronic device 200 may perform a multiply and accumulate (MAC) operation with Xooi, Xo1i, and Woi in cycle i, where i may mean 0 and natural numbers.

Diagram 503 illustrates a circuit diagram performing a MAC operation.

The electronic device 200 may perform a multiplication operation of Woo and Xooo in cycle 0 and may store a result on a first accumulator 510. The electronic device 200 may perform a multiplication operation of Woi and Xooi in cycle i and may store a result on the first accumulator 510. Here, i may include natural numbers. The electronic device 200 may perform multiplication operations from cycle 0 to cycle i and may accumulate and store results on the first accumulator 510. The first accumulator 510 may include an adder 512 and a register 514. The first accumulator 510 may add a result value of a multiplication operation determined in cycle 0 and a result value of a multiplication operation determined in cycle i by using the adder 512. Subsequently, the first accumulator 510 may add result values and may register an added result in the register 514.

The electronic device 200 may perform a multiplication operation of Woo and Xo1o in cycle 0 and may store a result on a second accumulator 520. The electronic device 200 may perform a multiplication operation of Woi and Xo1i in cycle i and may store a result on the second accumulator 520. Here, i may include natural numbers. The electronic device 200 may perform multiplication operations from cycle 0 to cycle i and may accumulate and store results on the second accumulator 520. Multiplication between eight bits and four bits is the same as described in FIG. 3A above. In diagram 503, a section corresponding to multiplication between four bits (4 b×4 b) may not be used and may be deactivated. A multiplexer 530 may select one of two inputs based on a control signal. In diagram 503, an input corresponding to multiplication between four bits (4 b×4b) may not be selected and may be deactivated.

FIG. 5B illustrates a first embodiment of sharing input values among multiple MAC units when one or more MAC units illustrated in FIG. 5A are present.

According to FIG. 5B, the electronic device (e.g., the electronic device 200 of FIG. 2) may include multiple MAC units. Multiple MAC units may perform operation processes described in FIG. 5A respectively. Multiple MAC units may output at least one A8W8 result value respectively in one cycle.

The electronic device 200 may share input values among multiple MAC units to reduce communication overhead. For example, in a case of A8W8, the electronic device 200 may share a total of sixteen bits including IN0 (8 bits), IN1 (4 bits), and IN2 (4 bits).

A MAC k unit may receive weights of different 1×1 filters respectively from a MAC 0 unit in each cycle. k may mean natural numbers. The electronic device 200 may provide IN0 (8 bits), IN1 (4 bits), and IN2 (4 bits) as the same input values to respective MAC units. For example, the electronic device 200 may determine IN0 (8 bits), IN1 (4 bits), and IN2 (4 bits) by using input X1 and X2. X1 and X2 may mean 8-bit input values. A process of dividing IN0, IN1, IN2, and IN3 into eight-bit sections and four-bit sections and determining input values is described in FIG. 4A and FIG. 4B. The electronic device 200 may determine IN0 (8 bits), IN1 (4 bits), and IN2 (4 bits) corresponding to X1 and X2 and may share determined values with multiple MAC units.

Additionally, the electronic device 200 may determine an eight-bit IN3 value by assigning different weights (e.g., Woo, Wo1) in each cycle by using filter 0 and may transmit the IN3 value to MAC 0. However, an IN3 value may not be shared with another MAC unit unlike IN0 (8 bits), IN1 (4 bits), and IN2 (4 bits). The electronic device 200 may determine an eight-bit IN3 value by assigning different weights (e.g., W11, W1o) in each cycle by using filter 1 and may transmit the IN3 value to MAC 1. The electronic device 200 may determine an eight-bit IN3 value by assigning different weights (e.g., Wk1, Wko) in each cycle by using filter k and may transmit the IN3 value to MAC k. Here, k may mean 0 and natural numbers.

Diagram 540 illustrates a process in which the electronic device 200 performs convolution under control of the processor 210. In cycle 0, X1 may be assigned to Xooo, X2 may be assigned to Xo1o, and W may be assigned to Woo. One MAC unit may perform a multiplication operation of Xooo and Woo and may perform a multiplication operation of Xo1o and Woo in one cycle (e.g., cycle 0). The electronic device 200 may obtain a result value of A8W8 by using result values of two multiplication operations. In cycle 1, a MAC operation may be performed with Xoo1, Xo11, and Wo1. The electronic device 200 may perform a MAC operation with Xooi, Xo1i, and Woi in cycle i, where i may mean 0 and natural numbers. Characters representing natural numbers may include i, j, and k, but this is merely a difference in notation, and meanings of respective characters may be the same in representing 0 and natural numbers.

The electronic device 200 may perform operations of a plurality of filters in parallel for the same input value. The electronic device 200 according to this document may reduce latency time associated with performing operations by performing operations simultaneously in multiple MAC units, unlike a serial connection manner in which an operation is performed in one MAC unit and then an operation is performed after waiting for a result value. An intermediate output result of convolution may be accumulated on a register of an accumulator in a MAC unit. A MAC unit may store a result value whose accumulation is finished on memory (e.g., SRAM).

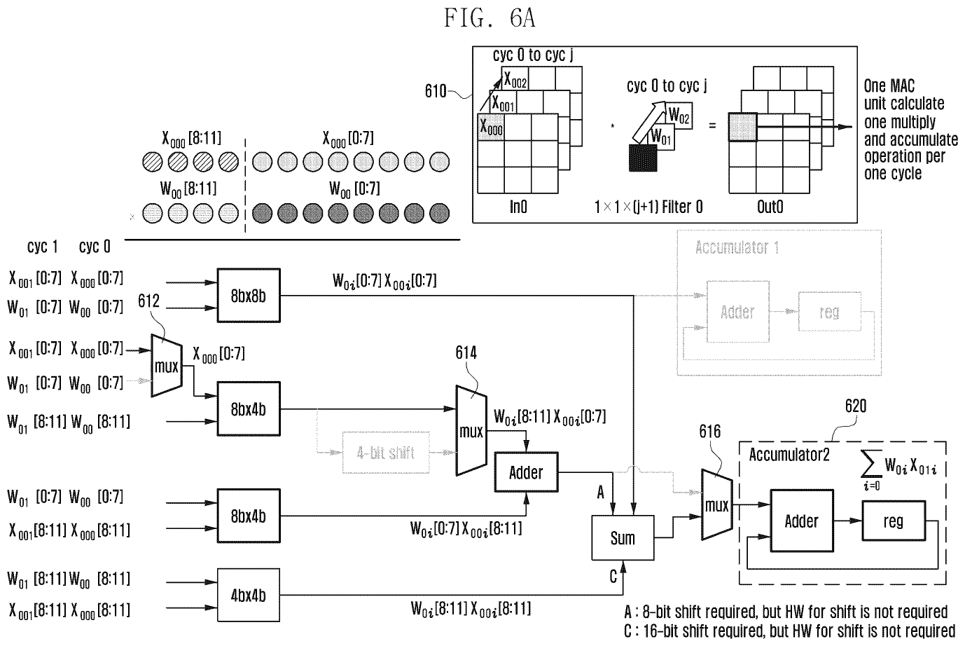

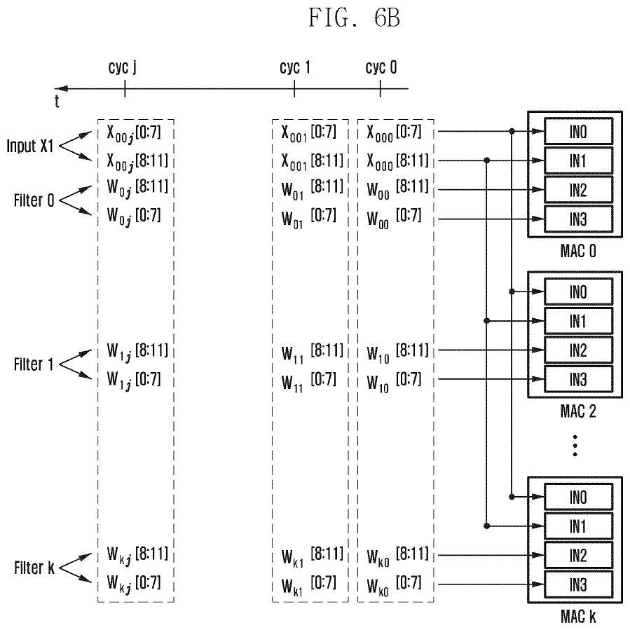

FIG. 6A illustrates a process of obtaining an A12W12 result through multiplication and sum operations by using a MAC unit according to various embodiments.

According to FIG. 6A, the processor (e.g., the processor 210 of FIG. 2) may divide upper four bits of first bit string data into a first section (e.g., the first section 401 of FIG. 4A) (IN1) and may divide lower eight bits of the first bit string data into a second section (e.g., the second section 402 of FIG. 4A) (IN0) for two 12-bit data. The processor 210 may divide upper four bits of second bit string data into a third section (e.g., the third section 403 of FIG. 4A) (IN2) and may divide lower eight bits of the second bit string data into a fourth section (e.g., the fourth section 404 of FIG. 4A) (IN3). A process of dividing IN0, IN1, IN2, and IN3 into eight-bit sections and four-bit sections and determining input values is described in FIG. 4A and FIG. 4B. In FIG. 6A, upper four bits and lower eight bits are described as being divided for convenience, but a dividing method is not limited thereto and may vary depending on settings. The first bit string data and the second bit string data may include data having twelve bits (e.g., image data).

Diagram 610 illustrates a process in which the electronic device 200 performs convolution.

In cycle 0, input value X1 may be assigned to Xooo and weight W may be assigned to Woo. X1 and W may include twelve-bit data. Twelve-bit data may be divided into upper four bits and lower eight bits or may be divided into upper eight bits and lower four bits. FIG. 6A is described by assuming that twelve-bit data are divided into upper four bits and lower eight bits, but a dividing manner is not limited thereto and may vary depending on settings.

One MAC unit may perform a multiplication operation of Xooo and Woo in one cycle (e.g., cycle 0). The electronic device 200 may perform a MAC operation with X1 and W. The electronic device 200 may perform a multiplication between eight bits of X1 and W and may obtain a first result value.

The electronic device 200 may perform a multiplication between eight bits of X1 and four bits of W. Further, the electronic device 200 may perform a multiplication between eight bits of W and four bits of X1. The electronic device 200 may perform multiplication between eight bits and four bits and may obtain a second result value by adding respective result values.

The electronic device 200 may perform a multiplication between four bits of X1 and four bits of W and may obtain a third result value. The electronic device 200 may obtain an A12W12 result for one cycle (e.g., cycle 0) by adding the first result value, the second result value, and the third result value all together.

The electronic device 200 may perform a MAC operation with Xooi and Woi in cycle i, where i may mean 0 and natural numbers.

One MAC unit may perform one A12W12 multiply and accumulate operation by multiplying Xooi and Woi in cycle i and may accumulate and store a result on a second accumulator 620. One MAC unit may repeatedly perform multiply and accumulate operations from cycle 0 and cycle 1 to cycle i and may accumulate and store results on the second accumulator 620. The first accumulator may be deactivated.

A may mean a result value of a multiplication operation between eight bits and four bits. C may mean a result value of a multiplication operation between four bits. The electronic device 200 may perform a sum operation by making A offset upward by eight bits and C offset upward by sixteen bits. The electronic device 200 may perform a sum operation by making A offset upward by eight bits and C offset upward by sixteen bits even without hardware for bit shifting. Multiplexers 612, 614, and 616 may select one of two inputs according to a control signal. In FIG. 6A, an input path not selected on the multiplexers 612, 614, and 616 may be indicated as being deactivated.

FIG. 6B illustrates a second embodiment in which input values are shared among multiple MAC units according to various embodiments. According to FIG. 6B, the processor (e.g., the processor 210 of FIG. 2) may divide upper four bits of first bit string data into a first section (e.g., the first section 401 of FIG. 4A) (IN1) and may divide lower eight bits of the first bit string data into a second section (e.g., the second section 402 of FIG. 4A) (IN0) for two 12-bit data. The processor 210 may divide upper four bits of second bit string data into a third section (e.g., the third section 403 of FIG. 4A) (IN2) and may divide lower eight bits of the second bit string data into a fourth section (e.g., the fourth section 404 of FIG. 4A) (IN3). The first bit string data and the second bit string data may include data having twelve bits (e.g., image data). Multiple MAC units may respectively perform operation processes described in FIG. 6A. Multiple MAC units may output one A12W12 result value respectively in one cycle.

The electronic device 200 may share input values among multiple MAC units to reduce communication overhead. For example, in a case of A12W12, the electronic device 200 may share a total of twelve bits including IN0 (8 bits) and IN1 (4 bits) corresponding to an X value.

A MAC k unit may receive weights of different 1×1 filters respectively from a MAC 0 unit in each cycle. k may mean natural numbers. The electronic device 200 may provide IN0 (8 bits) and IN1 (4 bits) as the same input values to respective MAC units. For example, the electronic device 200 may determine IN0 (8 bits) and IN1 (4 bits) by using input X1. X1 may mean a twelve-bit input value. A process of determining input values of IN0 and IN1 is described in FIG. 4B, and FIG. 6 is merely one of various embodiments and is not limited thereto. The electronic device 200 may determine IN0 (8 bits) and IN1 (4 bits) corresponding to X1 and may share determined values with multiple MAC units. Additionally, the electronic device 200 may determine a four-bit IN2 value and an eight-bit IN3 value by assigning different weights (e.g., Woo, Wo1) in each cycle by using filter 0 and may transmit them to MAC 0. However, IN2 and IN3 values may not be shared with another MAC unit unlike IN0 (8 bits) and IN1 (4 bits). The electronic device 200 may determine a four-bit IN2 value and an eight-bit IN3 value by assigning different weights (e.g., W11, W1o) in each cycle by using filter 1 and may transmit them to MAC 1. The electronic device 200 may determine a four-bit IN2 value and an eight-bit IN3 value by assigning different weights (e.g., Wk1, Wko) in each cycle by using filter k and may transmit them to MAC k. Here, k may mean 0 and natural numbers.

The electronic device 200 may perform operations of a plurality of filters in parallel for the same input value. The electronic device 200 according to this document may reduce latency time associated with performing operations by performing operations simultaneously in multiple MAC units, unlike a serial connection manner in which an operation is performed in one MAC unit and then an operation is performed after waiting for a result value. An intermediate output result of convolution may be accumulated on a register of an accumulator in a MAC unit. A MAC unit may store a result value whose accumulation is finished on memory (e.g., SRAM).

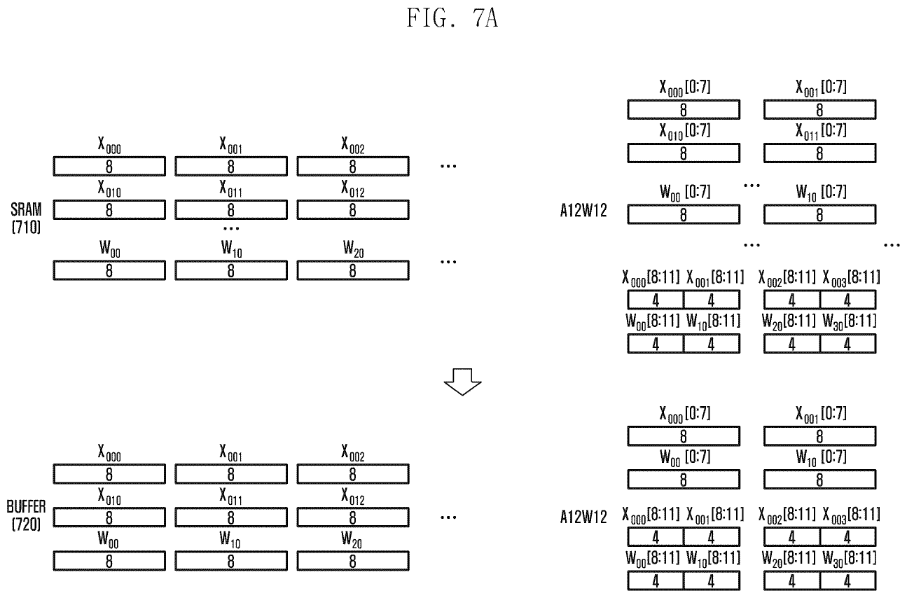

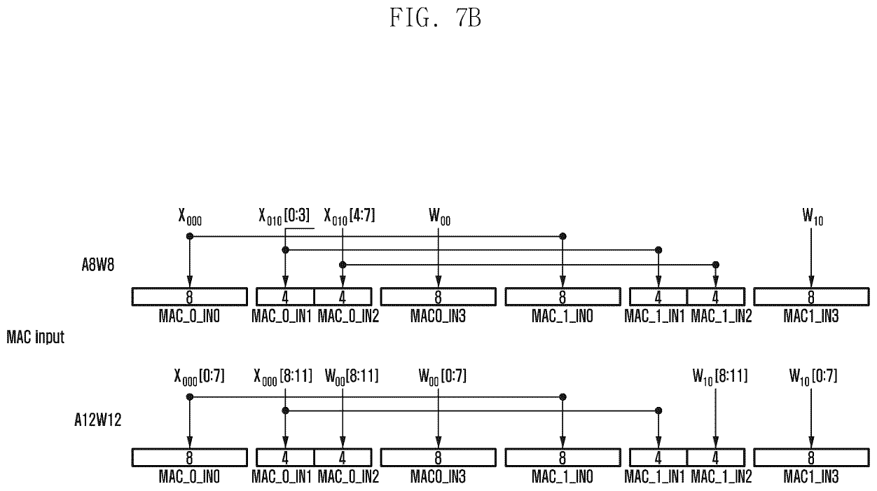

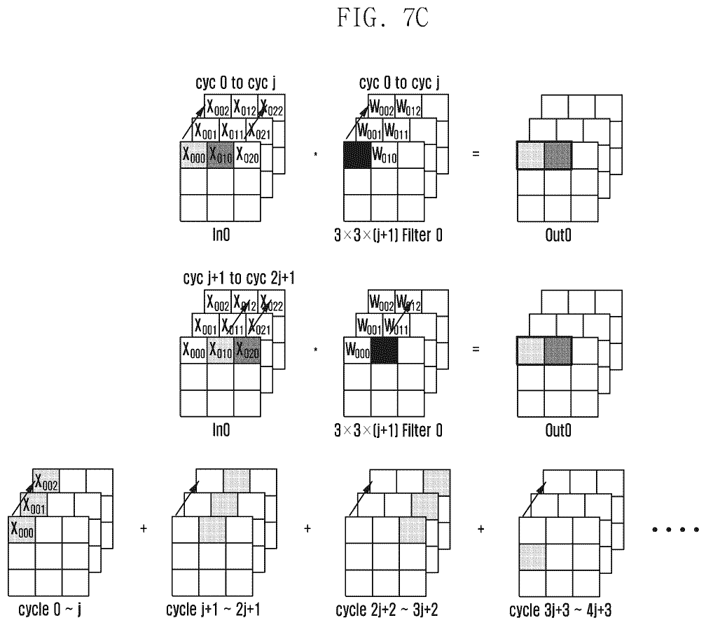

FIG. 7A and FIG. 7B illustrate a process of obtaining A8W8 and A12W12 results by packing data in units of 8 bits and 4 bits.

In FIG. 7A, data corresponding to A8W8 may have a size of 8 bits. A8W8 may mean activation 8bit and weight 8bit. Activation may mean a size of input data. Weight may mean a variable for adjusting an influence that input data exerts on a result.

Data corresponding to A12W12 may have a size of 12 bits. Because a general computer system uses 32 bits or 64 bits, when receiving 12-bit data, both 32 bits and 64 bits may have remaining bits. For example, when a computer system receives 12-bit data into 32 bits, 8 bits may remain. Also, when a computer system receives 12-bit data into 64 bits, 4 bits may remain. According to one example, when learning data in an A12W12 form, A12W12 may have good efficiency compared to another system (e.g., A8W8), but wasted bits may occur.

An electronic device (e.g., the electronic device 200 of FIG. 2) disclosed in FIG. 7A may perform an operation by dividing twelve-bit data into four bits and eight bits. The electronic device 200 may simultaneously perform an operation for twelve bits and an operation for eight bits by adding three multiplexers (mux) and one bit shifter without adding a separate operation device. According to an embodiment, a processor (e.g., the processor 210 of FIG. 2) may determine whether to output a result of activation 8-bit, weight 8-bit (A8W8) or to output a result of activation 12-bit, weight 12-bit (A12W12) based on an external input. The electronic device 200 according to this document may selectively output an eight-bit result or a twelve-bit result by changing a calculation method on one MAC unit. The electronic device 200 may selectively perform deep learning based on training for eight-bit data and training for twelve-bit data.

According to FIG. 7A, an NPU SRAM 710 may load data for input X and weight W internally from DRAM (not illustrated). Loaded data may be shifted to a buffer 720 before being delivered to MAC units. The electronic device 200 may shift at least some of data of the SRAM 710 to the buffer 720.

According to FIG. 7B, the electronic device 200 may load three rows of data lines on the SRAM 710 for A8W8 and may load four rows of data lines on the SRAM 710 for A12W12.

The electronic device 200 may provide data included in the buffer 720 as inputs of a MAC unit by using a wire or a multiplexer (mux). For example, the electronic device 200 may provide X010[0:3] as an input of MAC_0_IN1 for A8W8 and may provide X000[8:11] as an input of MAC_0_IN1 for A12W12. For example, the electronic device 200 may provide X010[4:7] as an input of MAC_0_IN2 for A8W8 and may provide W00[8:11] as an input of MAC_0_IN2 for A12W12.

FIG. 7C illustrates a process of performing a 3×3 convolution operation in a case of A8W8 according to an embodiment.

According to FIG. 7C, the electronic device (e.g., the electronic device 200 of FIG. 2) may additionally accumulate eight times by moving a feature map corresponding to 1×1 in order to perform a 3×3 convolution operation.

The electronic device 200 may accumulate MAC operations of 1×1×(j+1) from cycle 0 to cycle j under control of a processor (e.g., the processor 210 of FIG. 2) and may perform operations by accumulating MAC operations from cycle j+1 to cycle 2j+1.

The electronic device 200 may obtain two 3×3×(j+1) convolution result values in total when accumulating a total of nine times while moving a feature map corresponding to 1×1.

FIG. 7C illustrates an embodiment of an operation in which, in a case of A8W8, one MAC unit applies a same 3×3×(j+1) filter in a convolution operation to two feature map regions simultaneously and obtains two values of an output feature map in parallel from two accumulators of the MAC unit.

A first accumulator of the MAC unit may accumulate multiply-and-accumulate operations of 1×1×(j+1) from cyc 0 to cyc j to obtain one value of an output feature map and may perform accumulated operations again from cyc j+1 to cyc 2j+1 after moving a feature map region by one cell. The first accumulator of the MAC unit may obtain a 3×3×(j+1) convolution operation result by accumulating such 1×1×(j+1) convolution operations a total of nine times in a 3×3 region.

A second accumulator of the MAC unit may perform an operation on a 3×3×(j+1) region one cell next to a feature map region on which an operation is performed on the first accumulator. The second accumulator of the MAC unit may perform an operation in a same process as the first accumulator. The second accumulator of the MAC unit may obtain a second result value of a 3×3×(j+1) convolution operation.

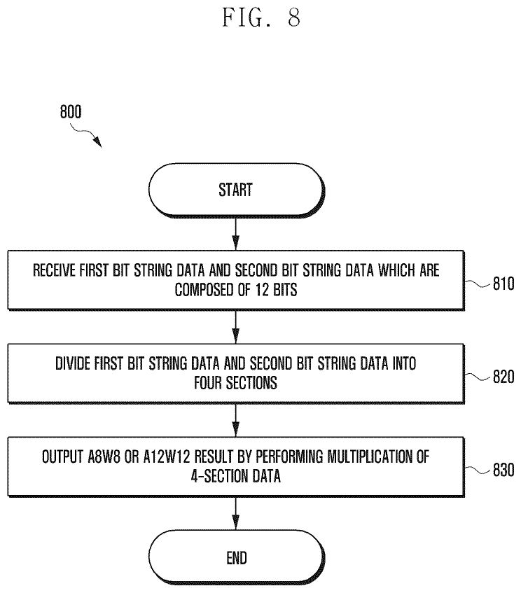

FIG. 8 illustrates an operation method of an electronic device performing an operation by using an artificial intelligence model according to an embodiment, in a flowchart.

The operations described through FIG. 8 may be implemented based on instructions that may be stored in a computer-readable medium or memory (e.g., the memory 220 of FIG. 2). An illustrated method 800 may be executed by an electronic device (e.g., the electronic device 200 of FIG. 2) described through FIGS. 1 to 7C above, and technical features described above will be omitted hereinafter. An order of respective operations of FIG. 8 may be changed, some operations may be omitted, and some operations may be performed simultaneously.

In operation 810, a processor (e.g., the processor 210 of FIG. 2) may receive first bit string data and second bit string data composed of twelve bits. The processor 210 may receive image data composed of twelve bits from a sensor (e.g., a camera). Bit string data composed of twelve bits may be composed of twelve-bit data from the beginning. Alternatively, bit string data composed of twelve bits may be generated as other bit data (e.g., eight-bit or sixteen-bit data) are converted (preprocessed) into a twelve-bit format.

In operation 820, the processor 210 may divide the first bit string data and the second bit string data into four sections. As an embodiment, the processor 210 may divide upper four bits of first bit string data into a first section and may divide lower eight bits of the first bit string data into a second section. The processor 210 may divide upper four bits of the second bit string data into a third section and may divide lower eight bits of the second bit string data into a fourth section. Alternatively, as an embodiment, the processor 210 may divide upper eight bits of the first bit string data into a first section and may divide lower four bits of the first bit string data into a second section. The processor 210 may divide upper eight bits of the second bit string data into a third section and may divide lower four bits of the second bit string data into a fourth section. Hereinafter, further details will be described by assuming that upper four bits of the first bit string data are divided into the first section and lower eight bits are divided into the second section to perform an operation, but a dividing method is not limited thereto and may vary depending on settings.

In operation 830, the processor 210 may output an A8W8 result or an A12W12 result by performing multiplication of four-section data. The processor 210 may perform multiplication of data of bits corresponding to the first section to bits corresponding to the fourth section and may output a result of activation 8-bit, weight 8-bit (A8W8) or may output a result of activation 12-bit, weight 12-bit (A12W12) by adding multiplication results.

According to an embodiment, the processor 210 may perform multiplication of data of the first section through the fourth section by using a MAC unit and may add multiplication results. The processor 210 may determine whether to output a result of activation 8-bit, weight 8-bit (A8W8) or to output a result of activation 12-bit, weight 12-bit (A12W12), which can be based on an external input (e.g., user input).

According to an embodiment, an operation circuit may include a plurality of multiplexers, a bit shifter, an adder, and storage space (accumulator). The processor 210 may select a first path capable of outputting a result of activation 8-bit, weight 8-bit (A8W8) or may select a second path capable of outputting a result of activation 12-bit, weight 12-bit (A12W12) within the operation circuit, which can be based on user input.

According to an embodiment, the processor 210 may select a third path capable of outputting a result of activation 16-bit, weight 16-bit (A16W16), which can be based on user input.

The electronic device 200 may include an A8W8-A12W12 MAC array and an A16W16 (or FP16) MAC array respectively. The electronic device 200 may selectively use either the A8W8-A12W12 MAC array or the A16W16 (or FP16) MAC array, which can be based on user input.

The electronic device 200 performing an operation by using an artificial intelligence model according to this document may output a result of A8W8 or may output a result of A12W12 for twelve-bit data input by changing an operation method for the same circuit. The electronic device 200 may support an A8W8 operation and may also support an A12W12 operation by adding three multiplexers and one bit shifter, thereby increasing deep-learning efficiency for image data.

An electronic device that performs a MAC operation may include at least one MAC unit, a memory (e.g., SRAM), at least one 8b×8b operator, at least one 8b×4b operator, at least one 4b×4b operator, a bit shifter, an adder, at least one accumulator, and a processor. The processor may receive first bit string data and second bit string data composed of 12 bits, divide first bit string data into 4 bits and 8 bits, divide second bit string data into 4 bits and 8 bits, output two 8-bit results corresponding to activation 8-bit, weight 8-bit (A8W8) by using the bit shifter and a first accumulator based on being determined to output a result of A8W8, and output one 12-bit result corresponding to activation 12-bit, weight 12-bit (A12W12) based on being determined to output a result of A12W12.

The processor may perform a multiplication operation between eight bits of first bit string data and four bits of first bit string data, perform a multiplication operation between eight bits of first bit string data and four bits of second bit string data, output a first result corresponding to A8W8 by using a bit shifter and the first accumulator, perform a multiplication operation between eight bits of first bit string data and eight bits of second bit string data and output a second result corresponding to A8W8 by using the second accumulator, and based on being determined to output a result of activation 12-bit, weight 12-bit (A12W12), may perform a multiplication operation between eight bits of first bit string data and eight bits of second bit string data, perform a multiplication operation between four bits of first bit string data and four bits of second bit string data, perform a multiplication operation between eight bits of first bit string data and four bits of second bit string data, perform a multiplication operation between eight bits of second bit string data and four bits of first bit string data, and output a third result corresponding to A12W12 by using at least one accumulator.

The processor, based on being determined to output a result of A8W8, may assign a weight input to eight bits of first bit string data, assign first data to eight bits of second bit string data, assign second data to four bits of first bit string data and second bit string data, and may perform multiplication operations respectively between eight bits of first bit string data and four bits of first bit string data and between eight bits of first bit string data and four bits of second bit string data, output a first result by using a bit shifter and the first accumulator, and perform a multiplication operation between eight bits of first bit string data and eight bits of second bit string data and output a second result by using the second accumulator.

The processor, based on being determined to output a result of A12W12, may assign a weight input to eight bits of first bit string data and to four bits of first bit string data, assign third data to eight bits and four bits of second bit string data, and may perform a multiplication operation between eight bits of first bit string data and eight bits of second bit string data, perform a multiplication operation between eight bits of first bit string data and four bits of second bit string data, perform a multiplication operation between eight bits of second bit string data and four bits of first bit string data, perform a multiplication operation between four bits of first bit string data and four bits of second bit string data, and output a third result by using a bit shifter and at least one accumulator.

The first section may refer to four bits of first bit string data, and the second section may refer to eight bits of first bit string data, and the third section may refer to four bits of second bit string data, and the fourth section may refer to eight bits of second bit string data, and the processor may determine a first result value by performing multiplication for bits corresponding to the second section and bits corresponding to the fourth section, perform multiplication for bits corresponding to the fourth section and bits corresponding to the third section, and may determine a second result value by shifting upward by four bits by using a bit shifter for a result value obtained by multiplication, and may determine a third result value by performing multiplication for bits corresponding to the fourth section and bits corresponding to the first section, and may output the first result value, and may perform a sum operation for the second result value and the third result value and may output the result.

The processor may perform a multiplication operation for bits corresponding to the second section and bits corresponding to the fourth section and may store a result.

The processor may perform multiplication operations for sections divided into eight bits for first bit string data and second bit string data composed of 12 bits and determine a first value, perform multiplication operations for eight-bit sections and four-bit sections and determines a second value, perform multiplication operations for sections divided into four bits and determine a third value, and may accumulate and store a result by summing the first value, the second value, and the third value.

The electronic device may include an operation circuit, a memory, and a processor. The operation circuit may include a plurality of multiplexers, a bit shifter, an adder, and a storage space include an accumulator. The processor may select a first path capable of outputting a result of activation 8-bit, weight 8-bit (A8W8), or may select a second path capable of outputting a result of activation 12-bit, weight 12-bit (A12W12), within the operation circuit. The selection may be based on a user input.

An operation method of an electronic device performing an operation by using an artificial intelligence model may include an operation of receiving first bit string data and second bit string data composed of 12 bits, an operation of dividing first bit string data into four bits and eight bits, an operation of dividing second bit string data into four bits and eight bits, an operation of outputting two 8-bit results corresponding to activation 8-bit, weight 8-bit (A8W8) by using a bit shifter and a first accumulator based on being determined to output a result of A8W8, and an operation of outputting one 12-bit result corresponding to activation 12-bit, weight 12-bit (A12W12) based on being determined to output a result of A12W12.

What is claimed is:

1. An electronic device, comprising:
at least one multiply and accumulate (MAC) unit;
memory for storing instructions;
at least one 8b×8b operator;
at least one 8b×4b operator;
at least one 4b×4b operator;
a bit shifter;
an adder;
at least one accumulator;
a processor; and
the instructions, when executed by the processor, controlling the electronic device to:
receive first bit string data and second bit string data composed of twelve bits;
divide the first bit string data into four bits and eight bits;
divide the second bit string data into four bits and eight bits;
output, based on being determined to output a result of activation 8-bit, weight 8-bit (A8W8), two 8-bit results corresponding to A8W8 by using the bit shifter and a first accumulator; and
output, based on being determined to output a result of activation 12-bit, weight 12-bit (A12W12), one 12-bit result corresponding to A12W12.

2. The electronic device of claim 1, wherein the instructions, when executed by the processor, by using at least one operator, control the electronic device to:
perform a multiplication operation between eight bits of the first bit string data and four bits of the first bit string data, and perform a multiplication operation between eight bits of the first bit string data and four bits of the second bit string data;
output a first result corresponding to A8W8 by using the bit shifter and the first accumulator;
perform a multiplication operation between eight bits of the first bit string data and eight bits of the second bit string data;
output a second result corresponding to A8W8 by using a second accumulator; and
based on being determined to output a result of A12W12:
perform a multiplication operation between eight bits of the first bit string data and eight bits of the second bit string data;
perform a multiplication operation between four bits of the first bit string data and four bits of the second bit string data;
perform a multiplication operation between eight bits of the first bit string data and four bits of the second bit string data;
perform a multiplication operation between eight bits of the second bit string data and four bits of the first bit string data; and
output a third result corresponding to A12W12 by using the at least one accumulator.

3. The electronic device of claim 1, wherein the instructions, when executed by the processor, control the electronic device, based on being determined to output a result of A8W8, to:
assign a weight input to eight bits of the first bit string data;
assign first data to eight bits of the second bit string data;
assign second data to four bits of the first bit string data and the second bit string data;
perform, by using at least one operator, multiplication operations respectively between eight bits of the first bit string data and four bits of the first bit string data and between eight bits of the first bit string data and four bits of the second bit string data, to output a first result by using the bit shifter and the first accumulator; and
perform a multiplication operation between eight bits of the first bit string data and eight bits of the second bit string data, to output a second result by using the second accumulator.

4. The electronic device of claim 1, wherein the instructions, when executed by the processor, control the electronic device, based on being determined to output a result of A12W12, to:
assign a weight input to eight bits of the first bit string data and to four bits of the first bit string data;
assign third data to eight bits and four bits of the second bit string data; and
by using at least one operator:
perform a multiplication operation between eight bits of the first bit string data and eight bits of the second bit string data;
perform a multiplication operation between eight bits of the first bit string data and four bits of the second bit string data;
perform a multiplication operation between eight bits of the second bit string data and four bits of the first bit string data;
perform a multiplication operation between four bits of the first bit string data and four bits of the second bit string data; and
output a third result by using the bit shifter and the at least one accumulator.

5. The electronic device of claim 1, wherein a first section refers to four bits of the first bit string data, a second section refers to eight bits of the first bit string data, a third section refers to four bits of the second bit string data, and a fourth section refers to eight bits of the second bit string data, and
wherein the instructions, when executed by the processor, control the electronic device to:
determine a first result value by performing multiplication for bits corresponding to the second section and bits corresponding to the fourth section;
perform multiplication for bits corresponding to the fourth section and bits corresponding to the third section;
determine a second result value by shifting upward by four bits by using the bit shifter for a result value obtained by multiplication;
determine a third result value by performing multiplication for bits corresponding to the fourth section and bits corresponding to the first section;
output the first result value; and
output a result by performing a sum operation for the second result value and the third result value.

6. The electronic device of claim 5, wherein the instructions, when executed by the processor, control the electronic device to perform a multiplication operation for bits corresponding to the second section and bits corresponding to the fourth section and to store a result.

7. The electronic device of claim 5, wherein the instructions, when executed by the processor, control the electronic device to:
perform multiplication operations for sections divided into eight bits for first bit string data and second bit string data composed of twelve bits to determine a first value;
perform multiplication operations for eight-bit and four-bit sections to determine a second value;
perform multiplication operations for sections divided into four bits to determine a third value; and
accumulate and store a result by summing the first value, the second value, and the third value.

8. An electronic device, comprising:
a memory for storing instructions;
a processor;
an operation circuit comprising a plurality of multiplexers, a bit shifter, an adder, and storage space comprising an accumulator; and
the instructions, when executed by the processor, controlling the electronic device to select, based on user input, a first path capable of outputting a result of activation 8-bit, weight 8-bit (A8W8) within the operation circuit, or to select a second path capable of outputting a result of activation 12-bit, weight 12-bit (A12W12).

9. The electronic device of claim 8, wherein the instructions, when executed by the processor, control the electronic device to select, based on user input, a third path capable of outputting a result of activation 16-bit, weight 16-bit (A16W16).

10. The electronic device of claim 8, wherein the instructions, when executed by the processor, control the electronic device to output two 8-bit results corresponding to A8W8, or to output one 12-bit result corresponding to A12W12.

11. A method for operating an electronic device performing a calculation by using an artificial intelligence model, the method comprising:
receiving first bit string data and second bit string data composed of twelve bits;
dividing the first bit string data into four bits and eight bits;
dividing the second bit string data into four bits and eight bits;
outputting two 8-bit results corresponding to activation 8-bit, weight 8-bit (A8W8) by using a bit shifter and a first accumulator based on being determined to output a result of A8W8; and
outputting one 12-bit result corresponding to activation 12-bit, weight 12-bit (A12W12) based on being determined to output a result of A12W12.

12. The method of claim 11, further comprising:
dividing upper four bits of the first bit string data into a first section and dividing lower eight bits of the first bit string data into a second section;
dividing upper four bits of the second bit string data into a third section and dividing lower eight bits of the second bit string data into a fourth section;
performing a multiplication operation between the second section corresponding to lower eight bits and the fourth section corresponding to lower eight bits, based on being determined to output a result of A8W8, and outputting a result;
generating the third section into eight-bit data by using a bit shifter and performing a multiplication operation with the fourth section, and performing a multiplication operation between the first section and the fourth section;
performing a multiplication operation between the second section corresponding to lower eight bits and the fourth section corresponding to lower eight bits, based on being determined to output a result of A12W12; and
performing a multiplication operation between sections corresponding to lower eight bits and upper four bits, and performing a multiplication operation between the first section corresponding to the upper four bits and the third section corresponding to the upper four bits.

13. The method of claim 11, further comprising:
determining a first result value by performing multiplication for bits corresponding to the second section and bits corresponding to the fourth section;
performing multiplication for bits corresponding to the fourth section and bits corresponding to the third section;
determining a second result value by shifting upward by four bits by using the bit shifter for a result value obtained by multiplication;
determining a third result value by performing multiplication for bits corresponding to the fourth section and bits corresponding to the first section;
outputting the first result value; and
performing a sum operation for the second result value and the third result value and outputting a result.

14. The method of claim 11, further comprising:
determining a first result value by performing multiplication for bits corresponding to the second section and bits corresponding to the fourth section;
performing multiplication for bits corresponding to the second section and bits corresponding to the third section, to determine a second result value by shifting upward by eight bits by using the bit shifter for a result value obtained by the multiplication operation;
performing multiplication for bits corresponding to the first section and bits corresponding to the third section, to determine a third result value by shifting upward by eight bits by using the bit shifter for a result value obtained by the multiplication operation;
performing multiplication for bits corresponding to the first section and bits corresponding to the fourth section, to determine a fourth result value by shifting upward by eight bits by using the bit shifter for a result value obtained by the multiplication operation; and
outputting a result by performing a sum operation for the first result value through the fourth result value.

15. The method of claim 11, further comprising:
performing a multiplication operation for bits corresponding to the second section and bits corresponding to the fourth section and storing a result.

16. The method of claim 11, further comprising:
performing a sum operation for a result value obtained by performing a multiplication operation between any one of bits corresponding to the second section or bits corresponding to the fourth section and bits corresponding to the third section, and a result value obtained by performing a multiplication operation between bits corresponding to the fourth section and bits corresponding to the first section; and
performing a multiplication operation between bits corresponding to the third section and bits corresponding to the first section and accumulating a result.

17. The method of claim 11, further comprising:
performing multiplication operations for sections divided into eight bits for first bit string data and second bit string data composed of twelve bits and determining a first value;
performing multiplication operations for eight-bit and four-bit sections and determining a second value;
performing multiplication operations for sections divided into four bits and determining a third value; and
accumulating and storing a result by summing the first value, the second value, and the third value.

18. The method of claim 11, wherein the electronic device comprises at least one multiply and accumulate (MAC) unit configured to perform multiplication and sum operations, and the MAC unit is operatively connected with a multiplexer outputting at least one signal among a plurality of signals and performs a deep learning operation for input values, and
wherein the method further comprises:
performing multiplication of bit string data of the first section through the fourth section by using the MAC unit, adding multiplication results; and
determining, based on an external input, whether to output a result of A8W8 or to output a result of A12W12.

19. The method of claim 11, comprising:
selecting, based on user input, a first path capable of outputting a result of A8W8 within the operation circuit, or selecting a second path capable of outputting a result of A12W12.

20. The method of claim 19, further comprising:
selecting, based on user input, a third path capable of outputting a result of activation 16-bit, weight 16-bit (A16W16).
